(19) United States
(12) Patent Application Publication
(10) Pub. No.: US 2021/0233430 A1
(43) Pub. Date: Jul. 29, 2021

(54) Interactive Teaching Doll

(71) Applicant: Anatummies LLC, Gold Beach, OR (US)

(72) Inventor: Erika Mirho, Gold Beach, OR (US)

(21) Appl. No.: 17/156,240

(22) Filed: Jan. 22, 2021

Related U.S. Application Data
(60) Provisional application No. 62/966,895, filed on Jan. 28, 2020.

(51) Int. Cl. G09B 23/34; A63H 3/00; A63H 3/02; A63H 3/16; A63H 3/48

(52) U.S. Cl. CPC G09B 23/34; A63H 3/003; A63H 3/48; A63H 3/16; A63H 3/02

(57) ABSTRACT

An interactive learning doll providing configurable internal organ systems includes an internal body cavity, a pillow mount disposed in the internal body cavity, the pillow mount having one or more organ attachments, and at least one of the organ attachments detachably coupled to an organ system comprising a linked set of organs.

### CROSS REFERENCE TO RELATED APPLICATIONS

This application claims priority and benefit under 35 USC 119(e) to U.S. Application Ser. No. 62/966,895, filed on Jan. 28, 2020, the contents of which are incorporated herein by reference in their entirety.

### BACKGROUND

Existing interactive learning dolls for teaching young children about human anatomical systems have several drawbacks. One such doll is Erwin the Little Patient, an educational toy that purports to teach kids about human anatomy. It comes with an internal set of color-coded organs that children are encouraged to manipulate with toy surgical instruments. The organs are in some cases connected to one another. The Erwin doll suffers from limitations such as a limited capability to utilize multiple organ systems in the same doll and no capability to track objects or materials as they pass through different organs of an organ system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an interactive learning doll 100 in one aspect.

FIG. 2 depicts the interactive learning doll 100 in another aspect.

FIG. 3 depicts a multi-tier anatomical system 300 in accordance with one embodiment.

FIG. 4 depicts the interactive learning doll 100 in another aspect.

FIG. 5 depicts the interactive learning doll 100 in another aspect.

### DETAILED DESCRIPTION

Embodiments of an interactive learning doll are described that include an internal body cavity and a pillow mount including one or more organ attachments. At least one of the organ attachments detachably couples to an organ system forming a linked set of organs. Here, “organ” means an object representing a biological organ. In one embodiment the organ system represents organs of the digestive tract. The organ system may be disposed between a first opening and a second opening in the internal body cavity, either or both of which may be open, sealed, or configured with a flap to selectively open or close. Each pillow representing an organ may include an attachment/detachment mechanism to the pillow mount, or only some of the organs may include such a mechanism.

The organs may comprise pillows or bags linked by hollow tubes, so that objects can pass from openings in the doll into the organ system, and/or from one organ to another within the organ system. Organs formed as pillows may include byways that couple to the hollow linking tubes. The tubes and byways, or bags, may thus form, for certain organ systems such as digestion, a continuous open channel from the first opening (e.g., mouth) to the second opening (e.g., anus). Other types of organ system may include an attachment to only one opening (e.g., reproductive system, pulmonary system).

The pillow mount to which the organ system is attached may itself include at least one attachment and detachment mechanism to the internal body cavity. The pillow mount, organs, and the linkages (connecting bands) of the organ system may be constructed entirely of fabric (excepting any attachment mechanisms added to them).

Other technical features may be readily apparent to one skilled in the art from the following figures, descriptions, and claims.

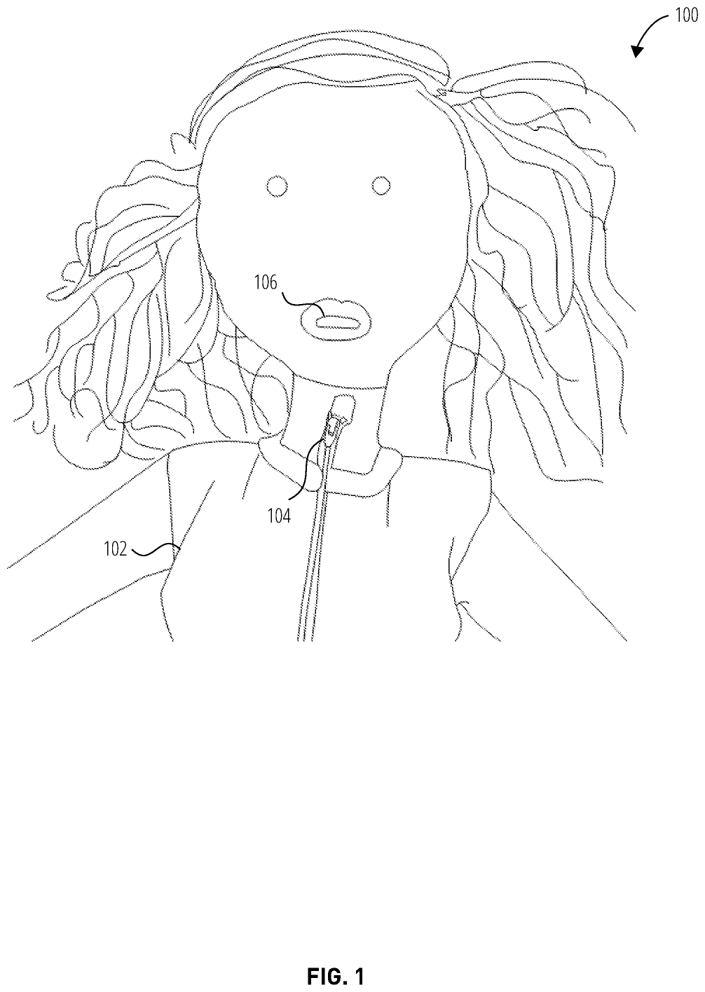

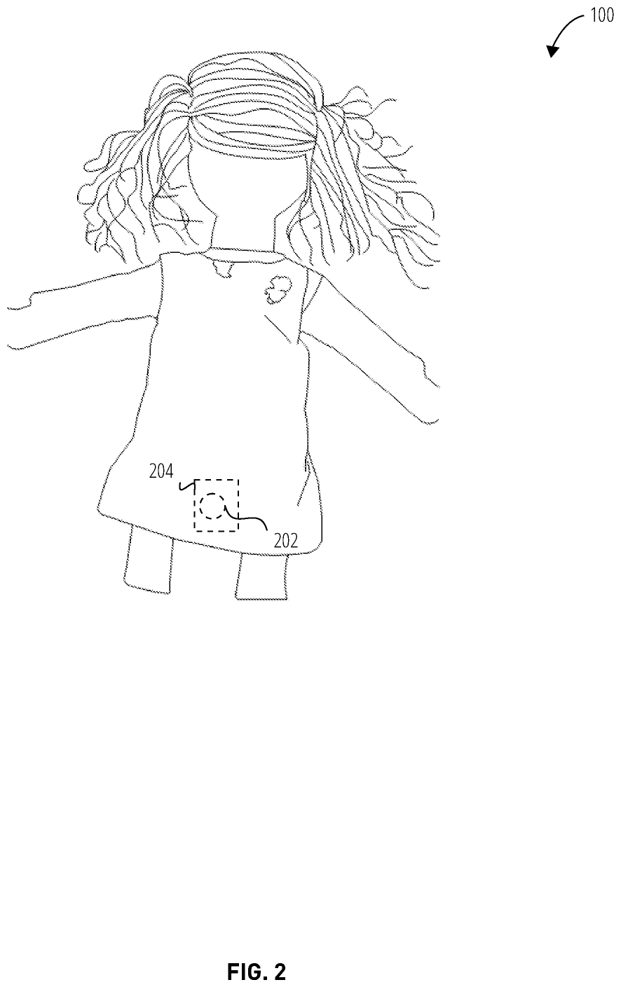

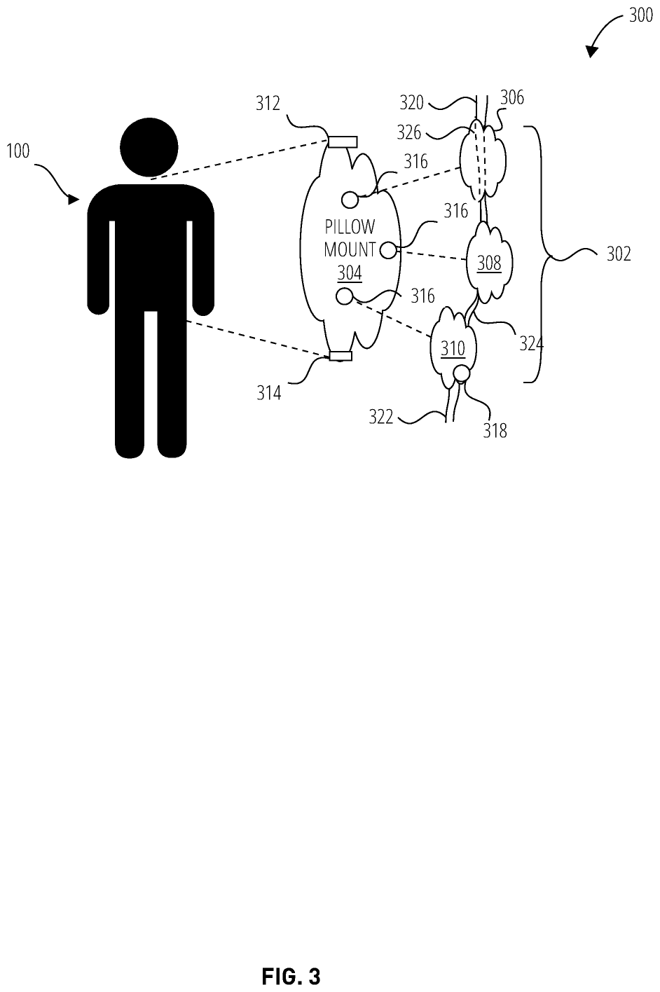

FIG. 1 depicts an interactive learning doll 100 in a front aspect. The interactive learning doll 100 is depicted in a rear aspect in FIG. 2. The interactive learning doll 100 includes an outer covering that can be opened using a zipper or other unlatching mechanism, such as snaps or Velcro, to access an internal body cavity 402. An internal opening is provided at the mouth of the doll. The internal opening leads to an anatomical system attached to a mounting pillow, as described further in FIG. 3-FIG. 5.

Features of the interactive learning doll 100 embodiment depicted in FIG. 1 and FIG. 2 include:

1. outer covering 102;

2. zipper 104;

3. internal opening 106;

4. nether opening 202 (anus); and

5. flap 204.

One or both of the internal opening 106 and nether opening 202 may be optional. If openings are not provided at these locations, there may nonetheless be attachments there for internal organ systems, as described in more detail below.

FIG. 3 depicts a multi-tier anatomical system 300 in one embodiment. One or more organ system 302 internal to the interactive learning doll 100 is exposed by opening the zipper 104 or other access mechanism of the outer covering 102. Features of the interactive learning doll 100 and multi-tier anatomical system 300 embodiment depicted in FIG. 3 include:

pillow mount 304;

organ system 302;

organ 306;

organ 308;

organ 310;

upper pillow attachment 312;

lower pillow attachment 314;

organ attachments 316;

organ attachment 318;

upper organ system attachment 320;

lower organ system attachment 322;

tubes 324; and

byways 326.

The multi-tier anatomical system 300 is constructed in two or more tiers. The first (base) tier is a mount in the form of a pillow mount 304 (fabric enclosing a filling material). The pillow mount 304 is enhanced with a number of features, including organ attachment 316 mechanisms (preferably snaps, but Velcro, clips, etc. may also be utilized) for attaching one or more individual organs 306, organ 308, 310, of one or more organ systems, and, optionally, an upper pillow attachment 312 and lower pillow attachment 314 for affixing the pillow mount 304 to the interior of the interactive learning doll 100 at one or more locations.

The organ system 302 comprises an upper organ system attachment 320 and a lower organ system attachment 322 for coupling to the internal opening 106 of the interactive learning doll 100 and the nether opening 202, respectively. In some implementations only one of the organ system attachments 320, lower organ system attachment 322 may be actually attached to the internal opening 106 at the mouth or the nether opening 202 at the rear of the interactive learning doll 100. Disengaging the organ system attachments 320, 322 enables replacement (interchanging) of an entire organ system with a different organ system in the same interactive learning doll housing. Alternatively, due to selective positioning of the organ attachments 316 on the pillow mount 304 specific to particular organ systems, the pillow mount 304 for a particular organ system may be replaced by one specifically configured (in size, position of organ attachments etc.) for a different organ system by disengaging one or more of the pillow attachments 312, 314 from the interactive learning doll 100. One or more of the organs may also include an organ attachment 318, enabling the addition of third, fourth, etc. tiers (organs or organ systems coupled to other organ systems).

The organ system 302 may be formed as a continuous closed system between the organ system attachments upper organ system attachment 320, lower organ system attachment 322, so that an object, air, or other materials may be passed from the (optional) internal opening 106 at the mouth to the nether opening 202, for learning purposes. One or both of the internal opening 106 and nether opening 202 (or other openings in the internal body cavity) may be sealed (or not present), or configurable with a flap 204, 502 that can be fixed over or removed from over the opening.

Each of the organs of the organ system 302, which may themselves be pillows formed with byways 326 for passing objects, may be linked by tubes 324 of preferably of fabric (or other flexible materials). Or one or more the organs may be hollow enclosures (e.g., fabric) with no stuffing (bags). In this manner, the entire interactive learning doll 100 may be manufactured primarily from fabric and pillows, simplifying the manufacturing process and inventory of necessary materials. The tubes 324 may also function to bind individual organs of the organ system 302 together, preventing loss, and demonstrating the interconnectivity of the various individual organs anatomically.

Although depicted with each of the organs having an organ attachment 316 to the pillow mount 304, in general not all organs need have such attachments. Some organs may be loose inside the body of the interactive learning doll. The tubes are again useful in this regard as they help prevent any loose organs from shifting too far out of position when replaced in the interactive learning doll after a learning session.

Although not depicted, in some implementations an individual organ of an organ system may itself include attachments for one or more other organs, and optionally tubes connecting to those organs. This creates a three-tiered anatomical system. In general, the anatomical system may have any number of tiers.

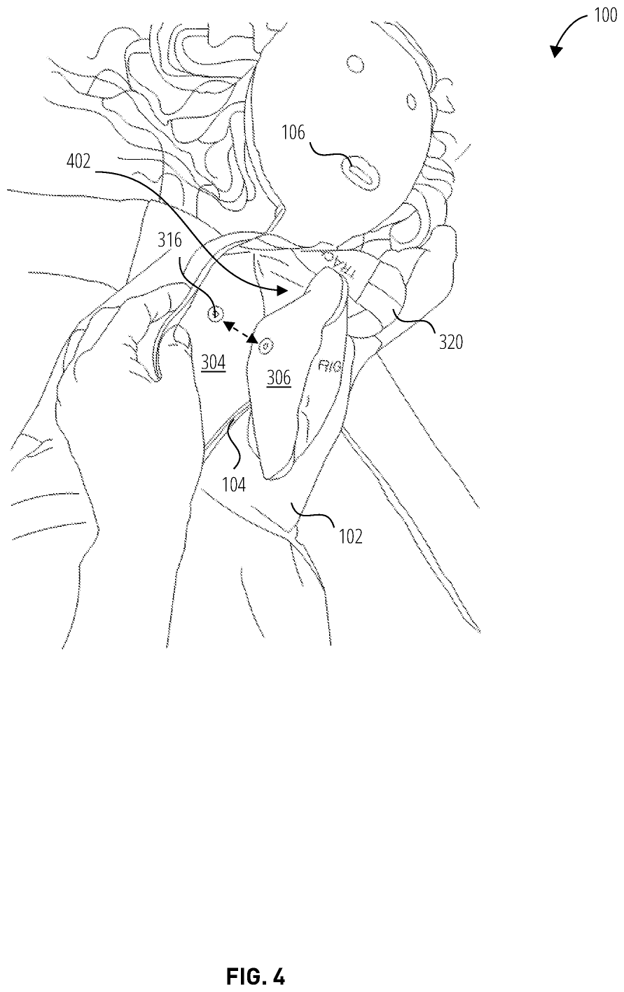

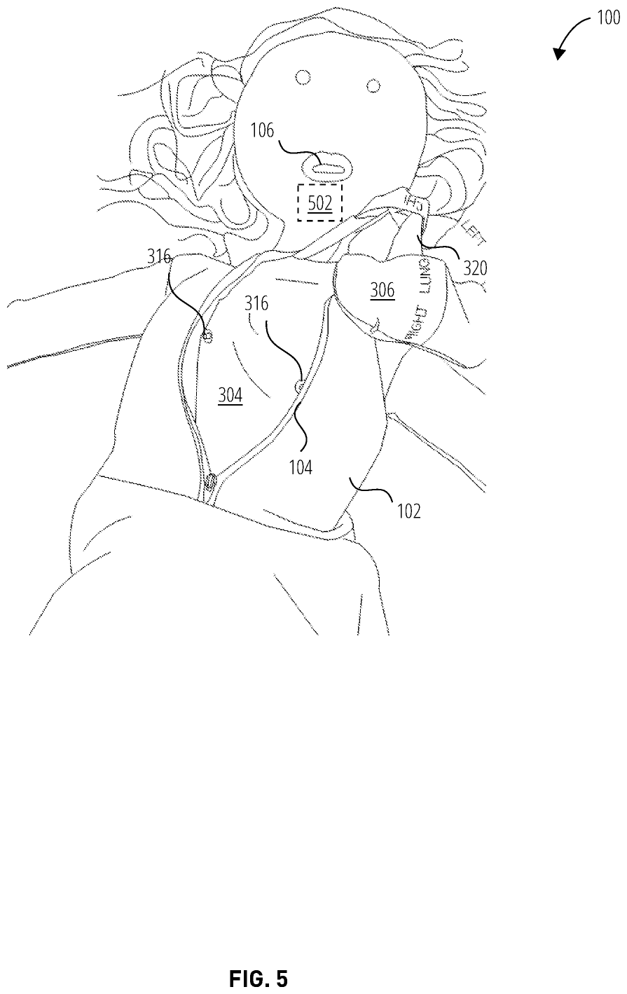

FIG. 4 and FIG. 5 depict example interactions with the multi-tier anatomical system 300 in an opened aspect, including opening the zipper 104 to expose the organ system 302 and detachment of organ 306 from the pillow mount 304 for examination and learning.

Within this disclosure, different entities may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. This phrase is not used herein to refer to something intangible.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. An interactive learning doll comprising:
an internal body cavity;
a pillow mount disposed in the internal body cavity, the pillow mount comprising one or more organ attachments; and
at least one of the organ attachments detachably coupled to an organ system comprising a linked set of organs.

2. The interactive learning doll of claim 1 wherein the organs are linked by hollow tubes.

3. The interactive learning doll of claim 2, wherein the organs comprise byways coupled to the hollow tubes.

4. The interactive learning doll of claim 2, wherein the tubes are constructed of fabric.

5. The interactive learning doll of claim 1 wherein the pillow mount comprises at least one organ attachment for one or more organs of different organ systems.

6. The interactive learning doll of claim 1, the pillow mount comprising at least one attachment and detachment mechanism to the internal body cavity.

7. The interactive learning doll of claim 1, the organ system comprising one or more organ system attachments detachably coupled to an internal opening and a nether opening of the internal body cavity.

8. An interactive learning doll comprising:
an internal body cavity comprising a pillow mount;
an interchangeable organ system comprising a plurality of pillows or bags; and
the organ system disposed between a first opening and a second opening in the internal body cavity, the pillow mount comprising one or more organ attachments for mounting the organ system.

9. The interactive learning doll of claim 8 wherein the pillows of the organ system represent organs linked together by fabric tubes.

10. The interactive learning doll of claim 9, wherein the the organs are bags coupled to the fabric tubes.

11. The interactive learning doll of claim 10, wherein the tubes and the organs form a continuous open channel from the first opening to the second opening.

12. The interactive learning doll of claim 8, further comprising:
configurable flaps to cover one or both of the first opening and second opening

13. The interactive learning doll of claim 1 wherein the pillow mount comprises at least one organ attachment for each organ of the organ system.

14. The interactive learning doll of claim 1, the pillow mount comprising at least one attachment and detachment mechanism to the internal body cavity.

15. An interactive learning doll comprising:
an internal body cavity;
a pillow mount disposed in the internal body cavity;
a plurality of interchangeable organ systems each comprising a linked set of organs and each configured to detachably couple to the pillow mount; and
at least one of the organ systems comprising a plurality of organs linked with fabric bands.

16. The interactive learning doll of claim 15 wherein at least some of the fabric bands are hollow tubes.

17. The interactive learning doll of claim 16, wherein the at least some of the organs comprise bags.

18. The interactive learning doll of claim 15 wherein at least some of the organs comprise one or more organ attachments for other organs.

19. The interactive learning doll of claim 15, the pillow mount comprising at least one attachment and detachment mechanism to the internal body cavity.

20. The pillow mount of claim 15 wherein at least one of the organ systems represents a digestive tract.
